(19) United States
(12) Patent Application Publication
(10) Pub. No.: US 2015/0009459 A1
(43) Pub. Date: Jan. 8, 2015

(54) LIQUID CRYSTAL DISPLAY PANEL AND LIQUID CRYSTAL DISPLAY DEVICE

(71) Applicant: Sharp Kabushiki Kaisha, Osaka-shi, Osaka (JP)

(72) Inventors: Yosuke Iwata, Osaka-shi (JP); Hidefumi Yoshida, Osaka-shi (JP); Mitsuhiro Murata, Osaka-shi (JP)

(21) Appl. No.: 14/368,561

(22) PCT Filed: Dec. 19, 2012
(86) PCT No.: PCT/JP2012/082862

§ 371 Date: Jun. 25, 2014

(30) Foreign Application Priority Data
Dec. 26, 2011 (JP) 2011-283983

(51) Int. Cl. G02F 1/1343; G02F 1/1335; G02F 1/1337

(52) U.S. Cl. CPC G02F 1/134363; G02F 1/1337; G02F 1/133528; G02F 2001/134318; G02F 2001/133541
USPC 349/98; 349/130; 349/96

(57) ABSTRACT

The present invention provides a liquid crystal display panel and a liquid crystal display device which have improved viewing angle characteristics due to having a multi-domain structure and the like and can sufficiently improve transmittance. The present invention relates to a liquid crystal display panel, including a first substrate and a second substrate facing each other; and a liquid crystal layer interposed between the substrates, the first substrate and/or the second substrate including a vertical alignment film on the liquid crystal layer side to align liquid crystal molecules, at a voltage lower than a threshold voltage, in the vertical direction to main surfaces of the substrates, the first substrate and/or the second substrate including a common electrode, the common electrode including a grid-shaped first common electrode, the first substrate including a pixel electrode, and the pixel electrode being branched.

### TECHNICAL FIELD

The present invention relates to a liquid crystal display panel and a liquid crystal display device. Specifically, the present invention relates to a liquid crystal display panel and a liquid crystal display device having improved viewing angle characteristics due to having a multi-domain structure and the like.

### BACKGROUND ART

Liquid crystal display panels, which are made of a pair of glass substrates or the like with a liquid crystal display element therebetween, are essential for a wide range of applications from business to household, owing to their advantages of being thin and light and low power consumption. In particular, various small to medium sized liquid crystal display panels having a small pixel pitch for, for example, tablet computers, cellular phones such as smartphones, game platforms, and on-vehicle devices such as car navigation equipment have been proposed and put into practical use. In these applications, liquid crystal display panels of various modes characterized by the arrangement of electrodes and the design of substrates for changing optical characteristics of the liquid crystal layer have been studied.

Display modes of liquid crystal display devices these days include: a vertical alignment (VA) mode in which liquid crystal molecules having a negative dielectric constant anisotropy are aligned vertically to the substrate surface; and an in-plane switching (IPS) mode and a fringe field switching (FFS) mode in which liquid crystal molecules having a positive or negative dielectric constant anisotropy are aligned horizontally to the substrate surface so that a transverse electric field can be applied to the liquid crystal layer.

In an IPS mode liquid crystal display device described in several studies (see Patent Literature 1, for example), a pixel electrode and a common electrode are arranged in an alternating arrangement in the width direction, and both of these electrodes are bent at one or more bend points. The shape of the bend of the pixel electrode and the common electrode is set such that both the intensity and the direction of the electric field applied to liquid crystal in each pixel can continuously vary.

### CITATION LIST

### Patent Literature

Patent Literature 1: JP 2002-23179 A

### SUMMARY OF INVENTION

### Technical Problem

Patent Literature 1 discloses a liquid crystal display device including a reflective sheet having a wavelength-dependent reflectance.

Viewing angle characteristics can be improved by varying alignment direction of liquid crystal molecules in one pixel to achieve a multi-domain structure or by varying the distribution of the electric field applied to the liquid crystals in one pixel to achieve a multi V-T structure. In the IPS mode display device proposed in Patent Literature 1, the pixel electrode disposed in a comb-tooth arrangement and the common electrode each have one or more bend points and are bent at different angles or in different directions, as shown in FIG. 2 of Patent Literature 1, so that the space between the electrodes varies in one pixel, which results in multi-domain structure and multi V-T structure (a structure in which a plurality of voltage-transmittance curves are observed in one pixel) to improve viewing angle characteristics.

However, the structure of Patent Literature 1 has the following drawback. In vertical alignment-type liquid crystal mode utilizing a transverse electric field, liquid crystal molecules located on the electrodes are not rotated, therefore the regions on the electrodes provide dark portions. Thus, in displays having a small pixel size and a small pixel pitch as 60 μm or smaller, the sideways V-shaped pixel electrode and common electrode disposed in an alternating arrangement in the width direction as in Patent Literature 1 increase the proportion of the electrodes in one pixel as compared with linearly arranged electrodes. This causes an insufficient transmittance (see FIGS. 14 and 15, for example).

As noted above, especially when the vertical alignment-type liquid crystal mode utilizing a transverse electric field is employed in displays with a small pixel pitch, it is difficult to combine high transmittance and viewing angle characteristics at oblique viewing angles.

The present invention is devised in view of the above situation of the art and aims to provide a liquid crystal display panel and a liquid crystal display device which have improved viewing angle characteristics due to having a multi-domain structure and the like and can sufficiently improve transmittance.

### Solution to Problem

In studies to combine high transmittance and high viewing angle characteristics in liquid crystal display panels and liquid crystal display devices of a vertical alignment-type utilizing a transverse electric field, the inventors have focused on the electrode structure to control the alignment of liquid crystal molecules. Taking note of the fact that transmittance is increased by decreasing the proportion of electrodes in one pixel, the inventors have developed a vertical alignment-type liquid crystal mode which utilizes a transverse electric field and in which a common electrode is arranged around each pixel and a branched pixel electrode is arranged in the center of the pixel. This decreases the proportion of electrodes in one pixel and thereby provides a high transmittance especially when the pixel pitch is 60 μm or smaller. Further, it has been found out that such an electrode structure can provide a multi-domain structure and thereby improve viewing angle characteristics. For example, the liquid crystal molecules can be tilted toward the upper, lower, right, and left of the pixel to form four domains. The inventors further have found out that, especially if (1) a pixel electrode having a shape of two Ys joined one above the other is disposed in the center of each pixel, as shown in FIG. 1, and (2) an electric field is applied between the pixel electrode and the common electrode which may be in the same substrate as the pixel electrode or in the opposing substrate, the loss of transmittance can be sufficiently prevented even in a small pixel having a pixel pitch of 60 μm or smaller, while viewing angle characteristics can be improved due to the multi-domain structure such as four domains and a multi V-T structure. Thus, the inventors found that the above problem could successfully be solved by the structure described above, and have arrived at the present invention.

That is, the present invention relates to a liquid crystal display panel including: a first substrate and a second substrate facing each other; and a liquid crystal layer interposed between the substrates, the first substrate and/or the second substrate including a vertical alignment film on the liquid crystal layer side to align liquid crystal molecules, at a voltage lower than a threshold voltage, in the vertical direction to main surfaces of the substrates, the first substrate and/or the second substrate including a common electrode, the common electrode including a grid-shaped first common electrode, the first substrate including a pixel electrode, and the pixel electrode being branched.

The grid-shaped first common electrode includes, in a plan view of the main surfaces of the substrates, a linear portion extending in a longitudinal direction and a linear portion extending in a lateral direction. The linear portion extending in a longitudinal direction and the linear portion extending in a lateral direction intersect each other and are typically arranged at least around each pixel. Here, the phrase “arranged around each pixel” means that, as long as the effects of the present invention can be exerted, the linear portions may substantially overlap the periphery of each pixel (borders between pixels) in a plan view of the main surfaces of the substrates.

In the liquid crystal display panel of the present invention, the pixel electrode is preferably disposed in a grid surrounded by the first common electrode in a plan view of main surfaces of the substrates. The phrase “disposed in a grid surrounded by the first common electrode” herein preferably means that the pixel electrode does not overlap the first common electrode and is disposed inside the first common electrode in a plan view of the main surfaces of the substrates.

In the liquid crystal display panel of the present invention, the pixel electrode preferably includes a linear portion, and both ends of the linear portion are preferably bifurcated. The furcated portions preferably have substantially the same length and may be Y-shaped or T-shaped. The linear portion may also be read as a bar-shaped portion.

The pixel electrode preferably includes a plurality of linear portions, and the plurality of linear portions preferably intersect each other. Each linear portion may have a length greater than the width of the linear portion. The linear portion may or may not have a constant width. The plurality of linear portions may be arranged to form a pattern (in the present description, also referred to as T-shape) in which the linear portions intersect each other at right angles or a pattern (also referred to as Y-shape) in which the linear portions intersect at acute angles or obtuse angles.

The first substrate and/or the second substrate may include at least one common electrode. The common electrode preferably further includes a second common electrode, and the second common electrode preferably overlaps at least part of the pixel electrode or the first common electrode. The second common electrode is preferably grid-shaped or planar. In one preferred mode, an electrically resistant layer is arranged between the second common electrode and another layer. The electrically resistant layer is preferably an insulating layer. The insulating layer herein is at least regarded as an insulating layer in the art to which the present invention belongs. Here, the phrase “an electrically resistant layer is arranged between the second common electrode and another layer” means that, for example, the electrically resistant layer is arranged between the second common electrode and the liquid crystal layer.

In the liquid crystal display panel of the present invention, the pixel electrode and the first common electrode preferably each include a linear portion, and the space between the linear portion of the pixel electrode and the linear portion of the first common electrode preferably varies in one pixel. By varying the space between these linear portions in one pixel, the electric field intensity can be varied in the pixel. As a result, a multi V-T structure can be suitably achieved. Specifically, the linear portion of the pixel electrode is preferably diagonal, not parallel, to the linear portion of the common electrode.

The pixel electrode and/or the first common electrode preferably include/includes a linear portion including one or more bend points. The bend point herein means a point from which two linear portions extend, not a point from which three or more linear portions extend. This also helps to suitably achieve a multi V-T structure.

The pixel electrode preferably has a shape which allows liquid crystal molecules to be aligned in at least four directions, at a voltage not lower than a threshold voltage, in a plan view of main surfaces of the substrates. If the pixel electrode has a shape of, for example, two identically-shaped Ys joined one above the other, liquid crystal molecules can be suitably aligned in at least four directions at a voltage not lower than a threshold voltage.

In the liquid crystal display panel of the present invention, either one of the first substrate and the second substrate preferably includes a grid-shaped common electrode. For example, in one preferred mode, only the first substrate includes a grid-shaped common electrode. In another preferred mode, only the second substrate includes a grid-shaped common electrode.

It is also preferred that both of the first substrate and the second substrate include a grid-shaped common electrode.

In one preferred mode, the liquid crystal display panel further includes a polarizing plate, and the polarizing plate is a linearly polarizing plate. In another preferred mode, the liquid crystal display panel further includes a polarizing plate, and the polarizing plate is a circularly polarizing plate.

In the liquid crystal display panel of the present invention, the liquid crystal layer preferably includes liquid crystal molecules having a positive dielectric constant anisotropy. It is also preferred that the liquid crystal layer includes liquid crystal molecules having a negative dielectric constant anisotropy.

Further, the first substrate and the second substrate each preferably include an electrode. This provides a potential difference between the substrates, and the electric field rotates the liquid crystal molecules to achieve high-speed response.

In one preferred mode of the present invention, the pixel electrode and the first common electrode are disposed in the same layer, as shown in FIG. 2. The pixel electrode and the first common electrode may be disposed in different layers as long as the effects of the present invention can be exerted. Here, the phrase “disposed in the same layer” means that these electrodes are in contact with a common component (e.g., insulating layer, liquid crystal layer) at the liquid crystal layer-side and/or the side opposite to the liquid crystal layer-side.

The linear portions of the pixel electrode and the first common electrode each preferably have a width of, for example, 2 μm or greater. The width of the gap (also referred to as space in the present description) between the linear portion of the pixel electrode and the linear portion of the first common electrode which are lying along each other is preferably, for example, 2 μm to 10 μm.

The first substrate and/or the second substrate include/includes a vertical alignment film on the liquid crystal layer side to align liquid crystal molecules, at a voltage lower than a threshold voltage, in the vertical direction to main surfaces of the substrates. The phrase “aligned in the vertical direction” herein at least satisfies the state regarded as being aligned in the vertical direction to the main surfaces of the substrates in the art to which the present invention belongs, including a mode of alignment in the substantially vertical direction. The liquid crystal molecules in the liquid crystal layer are preferably substantially composed of liquid crystal molecules which align in the vertical direction to the main surfaces of the substrates at a voltage lower than a threshold voltage. Liquid crystal display panels of such a vertical alignment-type are advantageous to achieve properties including wide viewing angle and high contrast and thus have been used in wider range of applications. The threshold voltage herein means, for example, a voltage value that provides a transmittance of 5% relative to the transmittance in the bright state taken as 100%.

It is preferable that the pixel electrode and the first common electrode can have different potentials. The phrase “can have different potentials” at least means that a driving operation to generate different electric potentials can be implemented. This makes it possible to suitably control the electric field applied to the liquid crystal layer. The pixel electrode and the first common electrode can have different potentials if, for example, each pixel electrode is driven by a TFT of the corresponding pixel while the first common electrode which is grid-shaped and common to all the pixels is driven by another TFT.

The second common electrode may be grid-shaped or planar. Preferred examples of the mode of the planar electrode herein include a mode in which electrode portions of all the pixels are electrically connected. In one example, the common electrode of the first substrate may be grid-shaped and the common electrode of the second substrate may be grid-shaped or planar. Preferred examples of the mode of the substrates with the common electrodes and pixel electrodes include: a mode in which the first substrate includes a grid-shaped first common electrode and pixel electrodes each including a linear portion, and both ends of the linear portion are bifurcated; a mode in which the first substrate includes pixel electrodes each including a linear portion, both ends of the linear portion being bifurcated, and the second substrate includes a grid-shaped first common electrode; a mode in which the first substrate includes a grid-shaped first common electrode and pixel electrodes each including a linear portion, both ends of the linear portion being bifurcated, and the second substrate includes a planer second common electrode; and a mode in which the first substrate includes a grid-shaped first common electrode and pixel electrodes each including a linear portion, both ends of the linear portion being bifurcated, and the second substrate includes a grid-shaped second common electrode.

The planar electrode may include an alignment-controlling structure such as a rib or a slit on part thereof, or may include the alignment-controlling structure in the center of each pixel in a plan view of the main surfaces of the substrates. Preferably, the planar electrode includes substantially no alignment-controlling structure.

When an electric field generated between the pixel electrode and the first common electrode and/or the second common electrode is applied to the liquid crystal layer, the liquid crystal layer usually provides a potential difference containing a component horizontal to the main surfaces of the substrates at a voltage not lower than a threshold voltage. The phrase “component horizontal to the main surfaces” herein at least satisfies the state regarded as being horizontal in the art to which the present invention belongs.

At least one of the first substrate and the second substrate usually includes an alignment film on the liquid crystal layer side. As noted above, the alignment film is a vertical alignment film. Examples of the alignment film include alignment films produced from organic materials or inorganic materials and photo-alignment films produced from photoactive materials.

The first substrate and the second substrate in the liquid crystal display panel of the present invention form a pair of substrates to interpose the liquid crystal layer. The substrates are produced by, for example, forming wirings, electrodes, color filters, and the like on an insulating substrate (e.g., glass, resin) as a base.

It is suitable that the first substrate including pixel electrodes is an active matrix substrate. The liquid crystal display panel of the present invention may be of a transmission type, a reflection type, or a transflective type.

The present invention also relates to a liquid crystal display device including the liquid crystal display panel of the present invention. Preferred modes of the liquid crystal display panel in the liquid crystal display device of the present invention are the same as those of the liquid crystal display panel of the present invention described above. The liquid crystal display device is preferably used for small to middle sized devices including tablet computers, cellular phones such as smartphones, game platforms, and on-vehicle device such as car navigation equipment.

The configurations of the liquid crystal display panel and the liquid crystal display device of the present invention are not especially limited by other components as long as they essentially include these components, and other configurations usually used in liquid crystal display panels and liquid crystal display devices may appropriately be applied.

The aforementioned modes can be appropriately combined as long as the combination is not beyond the spirit of the present invention.

### Advantageous Effects of Invention

With the liquid crystal display panel and the liquid crystal display device of the present invention, excellent viewing angle characteristics can be achieved due to a multi-domain structure while transmittance can be sufficiently improved.

### BRIEF DESCRIPTION OF DRAWINGS

FIG. 1 is a schematic plan view showing a pixel electrode structure of a liquid crystal display panel according to Embodiment 1.

FIG. 2 is a schematic cross-sectional view of a liquid crystal display panel according to Embodiment 1.

FIG. 3 is a schematic cross-sectional view of a liquid crystal display panel according to a first modified example of Embodiment 1.

FIG. 4 is a schematic cross-sectional view of a liquid crystal display panel according to a second modified example of Embodiment 1.

FIG. 5 is a schematic cross-sectional view of a liquid crystal display panel according to a third modified example of Embodiment 1.

FIG. 6 is a schematic view showing a transmitted light distribution under application of a voltage of 6 V in an electrode structure of Embodiment 1; and polarization axes of a linearly polarizing plate.

FIG. 7 is a schematic view showing a transmitted light distribution under application of a voltage of 6 V in an electrode structure of Embodiment 1 with a circularly polarizing plate.

FIG. 8 is a schematic plan view of a pixel electrode structure of a liquid crystal display panel according to Embodiment 2.

FIG. 9 is a schematic view showing a transmitted light distribution under application of a voltage of 6 V in an electrode structure of Embodiment 2; and polarization axes of a linearly polarizing plate.

FIG. 10 is a schematic plan view of a pixel electrode structure of a liquid crystal display panel according to Embodiment 3.

FIG. 11 is a schematic view showing a transmitted light distribution under application of a voltage of 6 V in an electrode structure of Embodiment 3; and polarization axes of a linearly polarizing plate.

FIG. 12 is a schematic plan view of a pixel electrode structure of a liquid crystal display panel according to Embodiment 4.

FIG. 13 is a schematic view showing a transmitted light distribution under application of a voltage of 6 V in an electrode structure of Embodiment 4; and polarization axes of a linearly polarizing plate.

FIG. 14 is a schematic plan view showing a pixel electrode structure of a liquid crystal display panel according to Comparative Example 1.

FIG. 15 is a schematic view showing a transmitted light distribution under application of a voltage of 6 V in an electrode structure of Comparative Example 1; and polarization axes of a linearly polarizing plate.

FIG. 16 is a schematic plan view showing a pixel electrode structure of a liquid crystal display panel according to Comparative Example 2.

FIG. 17 is a schematic view showing a transmitted light distribution under application of a voltage of 6 V in an electrode structure of Comparative Example 2; and polarization axes of a linearly polarizing plate.

FIG. 18 is a graph showing γ characteristics in Embodiment 1 and Comparative Example 2 with linearly polarized light.

FIG. 19 is a graph showing γ characteristics in Embodiment 1 and Comparative Example 2 with linearly polarized light.

FIG. 20 is a graph showing γ characteristics in Embodiment 1 and Comparative Example 2 with linearly polarized light.

FIG. 21 is a graph showing γ characteristics in Embodiments 1 to 4 and Comparative Example 2 with linearly polarized light.

FIG. 22 is a graph showing γ characteristics in Embodiments 1 to 4 and Comparative Example 2 with linearly polarized light

FIG. 23 is a graph showing γ characteristics in Embodiments 1 to 4 and Comparative Example 2 with linearly polarized light.

FIG. 24 is a schematic view showing a transmitted light distribution under application of a voltage of 6 V in an electrode structure of Comparative Example 2 with a circularly polarizing plate.

FIG. 25 is a graph showing γ characteristics in Embodiment 1 and Comparative Example 2 with circularly polarized light.

FIG. 26 is a graph showing γ characteristics in Embodiment 1 and Comparative Example 2 with circularly polarized light.

FIG. 27 is a graph showing γ characteristics in Embodiment 1 and Comparative Example 2 with circularly polarized light.

FIG. 28 is a graph showing relation between pixel pitch and transmittance in the electrode structure of Embodiment 1 and the electrode structure of Comparative Example 1.

FIG. 29 is a schematic plan view showing a pixel electrode structure of a liquid crystal display panel according to Embodiment 5.

FIG. 30 is a schematic plan view showing a pixel electrode structure of a liquid crystal display panel according to Embodiment 6.

FIG. 31 is a schematic plan view showing a pixel electrode structure of a liquid crystal display panel according to Embodiment 7.

### DESCRIPTION OF EMBODIMENT

In the following, the present invention will be described in more detail with reference to embodiments thereof and drawings. The embodiments are not intended to limit the scope of the present invention. In the present description, “pixel” may be “picture element (sub-pixel)” if not otherwise specified. The planar electrode may include, for example, a dot-shaped rib and/or a slit as long as the planar electrode can be regarded as a planer electrode in the art to which the present invention belongs. Preferably, the planar electrode includes substantially no alignment-controlling structure. Since including thin film transistor (TFT) elements, a circuit substrate (the first substrate) in the embodiments is also referred to as a TFT substrate or an array substrate.

In the embodiments, components or parts having the similar function are provided with the same reference number.

### Embodiment 1

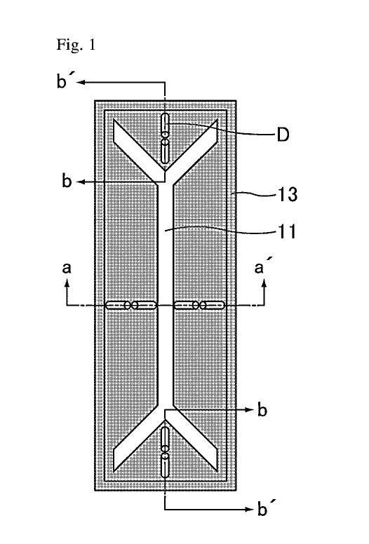

FIG. 1 is a schematic plan view showing a pixel electrode structure of a liquid crystal display panel according to Embodiment 1.

In a vertical alignment-type liquid crystal mode (TBA mode) which drives with a transverse electric field, a first common electrode 13 is disposed around a pixel, and a pixel electrode 11 is disposed in the center of the pixel with the shape as shown in FIG. 1. That is, the pixel electrode 11 includes a linear portion which has no bend point and is disposed parallel to the right and left portions of the first common electrode. The upper and lower portions of the linear portion of the pixel electrode 11 each are bifurcated (Y-shaped).

The first common electrode 13 can also serve as a first common electrode of adjacent pixels. The first common electrode 13 is arranged such that it overlaps bus lines (data bus line and gate bus line) in a plan view of the main surfaces of the substrates. The space between the linear portion of the pixel electrode and the linear portion of the first common electrode is preferably 10 μm or smaller. If the space is greater than 10 μm, an insufficient transverse electric field may be generated, to which liquid crystal molecules may not respond. If the pixel is larger and merely arranging the first common electrode around the pixel is insufficient to achieve the space of 10 μm or smaller, the first common electrode may be arranged in a finer grid pattern and the pixel electrode may be disposed in a grid surrounded by the first common electrode.

At the timing when the pixel is selected by a gate bus line, a voltage supplied from a data bus line is applied through a thin film transistor element (TFT) to the pixel electrode 11, which drives the liquid crystal material (the gate bus line, the data bus line, and the TFT element are not shown). In this embodiment, the pixel electrode 11 and the first common electrode 13 are formed in the same layer in the same substrate. The pixel electrode 11 and the first common electrode 13 are preferably arranged in the same layer (a layer on the liquid crystal layer side) in the same substrate or arranged in different substrates. Still, the electrodes may be formed in different layers in the same substrate as long as a voltage difference can be generated between the electrodes to apply a transverse electric field and as long as an effect of the present invention, that is, an effect of sufficiently improving transmittance, can be provided. The pixel electrode 11 is connected to a drain electrode extending from the TFT through a contact hole.

The thin film transistor element may be produced using a semiconductor such as an oxide semiconductor (e.g., IGZO [a complex oxide of indium, gallium, and zinc]) or an amorphous silicon. From the viewpoint of the effect of improving transmittance, oxide semiconductors are preferred. Oxide semiconductors, which exhibit higher carrier mobility than amorphous silicon, can reduce the area of the transistor in one pixel and increase the aperture ratio, thereby increasing the light transmittance of each pixel.

In this embodiment, the electrode width of the pixel electrode 11 is preferably, for example, 2 μm or greater. The space between the pixel electrode 11 and the first common electrode 13 is preferably, for example, 2 μm or greater. The upper limit of the space is preferably, for example, 10 μm.

The ratio (L/S) of the electrode width L to the space S between the electrodes is preferably, for example, 0.2 to 5. The lower limit is more preferably 0.4, and the upper limit is more preferably 3.

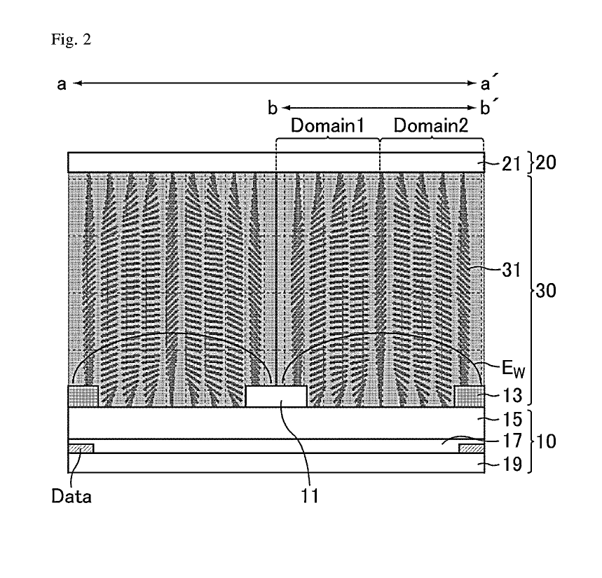

FIG. 2 is a schematic cross-sectional view of a liquid crystal display panel according to Embodiment 1.

When a potential difference is provided between the pixel electrode 11 and the first common electrode 13, a transverse electric field is generated, and liquid crystal molecules respond to the electric field. FIG. 2 shows an image of the distribution of directors at cross-sections along the line a-a′ and the line b-b′ of FIG. 1. Here, the cross-sectional view along the line from the midpoint of the line a-a′ to a′ is substantially the same as that along the line b-b′. In this case, liquid crystal molecules 31 are aligned in a direction parallel to the cross-sections such that the molecules on opposite sides of the center of the electrodes face each other. Thereby, two domains are formed. Accordingly, with the electrode structure shown in FIG. 1, the liquid crystal molecules can be aligned in four directions including the upward, downward, right, and left directions to achieve four domains. E_{w} shows the direction of the generated transverse electric field.

As shown in FIG. 2, the liquid crystal molecules in the TBA mode form two domains (Domain 1 and Domain 2) between the pixel electrode and the first common electrode. If a comb-tooth shaped electrode having a shape of sideways V is arranged as in Comparative Example 1 (the structure described in Patent Literature 1), the liquid crystal molecules are aligned in four directions, that is, directions of 45°, 225°, 135° and 315°. Thereby, four domains can be formed and as a result viewing angle characteristics can be improved. However, this sideways V-shaped electrode problematically increases the proportion of the electrode in one pixel. In the TBA modes, liquid crystal molecules located on the electrodes show almost no response, causing dark lines. Since the minimum possible width (about 2 μm) of the electrodes is independent of the pixel size, the smaller the pixel size, the greater the degree of reduction in transmittance, due to the dark lines on the electrodes.

The proportion of the electrodes in one pixel can be reduced by, for example, arranging the common electrode around the pixel and disposing a linear pixel electrode in the center of the pixel, as in Comparative Example 2. In this electrode structure, however, the liquid crystal molecules are aligned in only two directions of right and left, and thus only two domains can be formed. Though this provides transmittance, viewing angle characteristics are deteriorated.

In Embodiment 1, the pixel electrode includes a linear portion, and the upper portion and the lower portion of the linear portion are bifurcated so that the liquid crystal molecules in the upper portion and the lower portion of the pixel can be aligned in the upward direction and in the downward direction, respectively. With the electrode structure of Embodiment 1, a high transmittance is achieved while viewing angle characteristics can be improved by formation of four domains.

The liquid crystal display panel according to Embodiment 1 includes, as shown in FIG. 2, an array substrate 10, a liquid crystal layer 30, and a counter substrate 20 (color filter substrate) which are stacked in the stated order from the back side to the viewing side of the liquid crystal display panel. The liquid crystal display panel of Embodiment 1 vertically aligns the liquid crystal molecules at a voltage lower than a threshold voltage. As shown in FIG. 2, when a voltage difference between the pixel electrode 11 and the first common electrode 13 on the first substrate is not lower than a threshold voltage, an electric field generated between the pixel electrode 11 and the first common electrode 13 tilts the liquid crystal molecules in the horizontal direction between these electrodes, thereby controlling the amount of light transmitted. Insulating layers 15 and 17 each are produced using, for example, an oxide film (SiO₂), a nitride film (SiN), an acrylic resin film, or the like. These materials can be used in combination.

Though not shown in FIG. 1 and FIG. 2, a polarizing plate is disposed on each substrate at the side opposite to the liquid crystal layer. The polarizing plate may be a circularly polarizing plate or may be a linearly polarizing plate. An alignment film is disposed on the liquid crystal layer side of each substrate. The alignment films each may be an organic alignment film or may be an inorganic alignment film as long as they align the liquid crystal molecules vertically to the film surface.

The liquid crystal layer suitably and preferably has a layer thickness of 2 μm to 7 μm. The layer thickness of the liquid crystal layer herein is preferably calculated by averaging the thicknesses throughout the liquid crystal layer in the liquid crystal display panel.

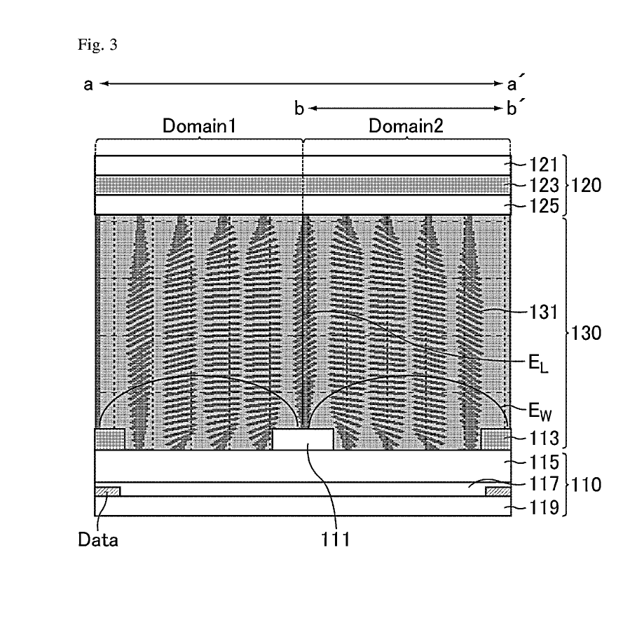

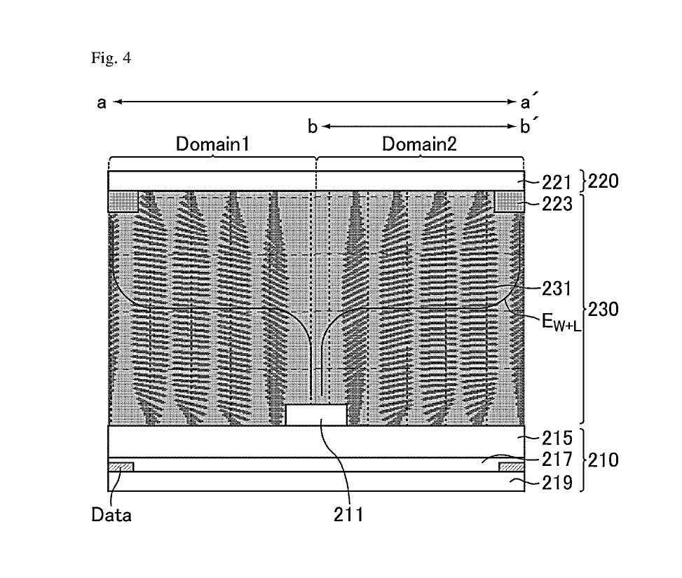

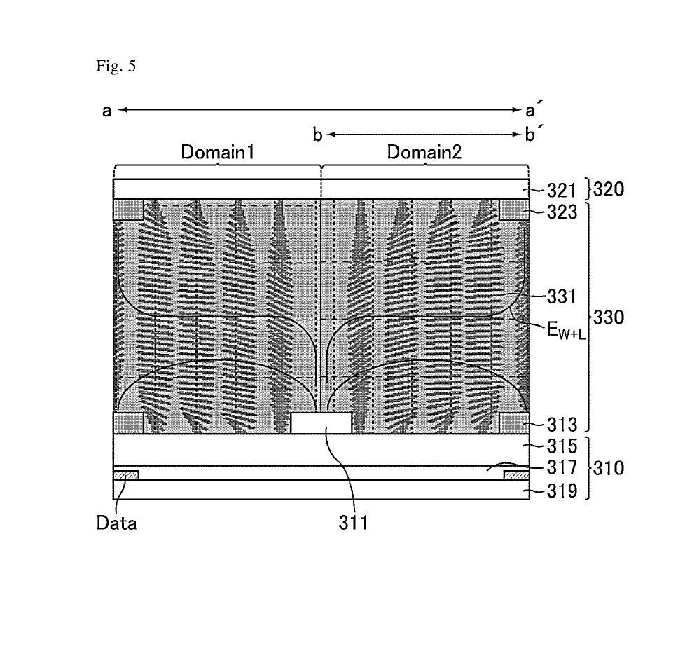

FIG. 3 is a schematic cross-sectional view of a liquid crystal display panel according to a first modified example of Embodiment 1. FIG. 4 is a schematic cross-sectional view of a liquid crystal display panel according to a second modified example of Embodiment 1. FIG. 5 is a schematic cross-sectional view of a liquid crystal display panel according to a third modified example of Embodiment 1.

An insulating layer (insulating film) 125 and a second common electrode 123 may be disposed on a counter substrate 120 such that they cover the entire or part of the pixel, as shown in FIG. 3. The counter substrate 120 faces an array substrate 110 including a comb-tooth electrode. In this case, a vertical electric field E_{L} is also generated between the second common electrode 123 of the counter substrate 120 and a pixel electrode 111 of the array substrate 110. Thereby, liquid crystal molecules 131 are tilted such that the molecules on opposite sides of the center of the pixel electrode 111 face each other to provide two domains (Domain 1 and Domain 2).

In FIG. 3, the first common electrode 113 and the pixel electrode 111 are disposed on the same substrate. Alternatively, the first common electrode 113 may be arranged on the counter substrate 120. The first common electrode may be arranged only on a counter substrate 220 as shown in FIG. 4, or may be arranged on both a substrate 310 on which a pixel electrode 311 is disposed and a counter substrate 320, as shown in FIG. 5. In these cases, both a transverse electric field and a vertical electric field (E_{W+L}) are generated between the pixel electrode 211 and the common electrode 223 or between the pixel electrode 311 and the common electrodes 313 and 323. Thereby, the liquid crystal molecules are aligned from the pixel electrode toward the common electrode to form two domains.

The liquid crystals may have a positive dielectric constant anisotropy or a negative dielectric constant anisotropy. It should be noted that the results of the embodiments and comparative examples shown below are all obtained using the structure shown in FIG. 2 (the structure of Embodiment 1) with liquid crystals having a positive dielectric constant anisotropy.

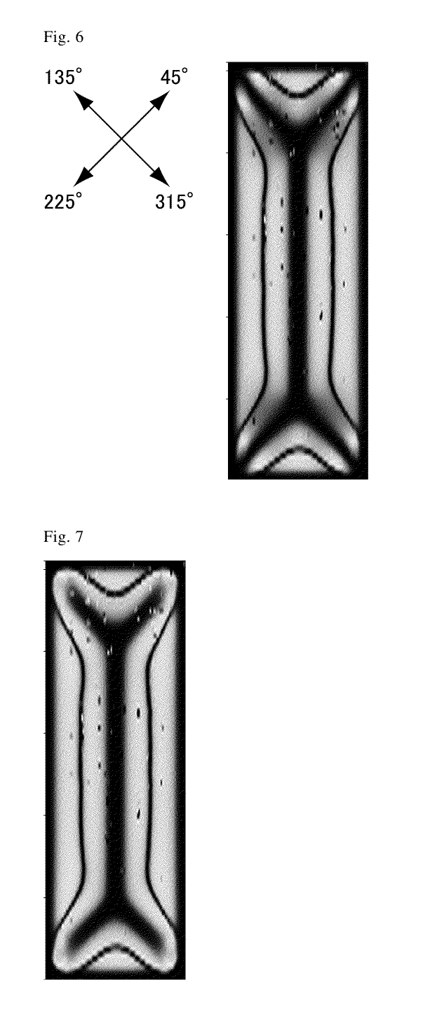

FIG. 6 is a schematic view showing a transmitted light distribution under application of a voltage of 6 V in an electrode structure of Embodiment 1; and polarization axes of a linearly polarizing plate. The double-headed arrows in the figure show polarization axes of the polarizing plate. The same shall apply in FIGS. 9, 11, 13, 15, and 17.

FIG. 6 and the below-mentioned FIGS. 15 and 17 respectively illustrate transmitted light distributions under application of a voltage of 6 V in the electrode structures of Embodiment 1, Comparative Example 1, and Comparative Example 2 each in the linearly polarized light system. All the pixels are 17 μm×51 μm in size. In Comparative Example 1 (FIG. 15), the transmittance is 10%, which is very low as compared with that in Embodiment 1 (FIG. 6), 23%. On the other hand, the transmittance in Comparative Example 2 (FIG. 17) is 22.4%, which is slightly lower than, but almost equal to, that in Embodiment 1. The transmittances in Embodiment 1, Comparative Example 1, and Comparative Example 2 are evaluated as good, poor, good, respectively.

FIG. 7 is a schematic view showing a transmitted light distribution under application of a voltage of 6 V in an electrode structure of Embodiment 1 with a circularly polarizing plate.

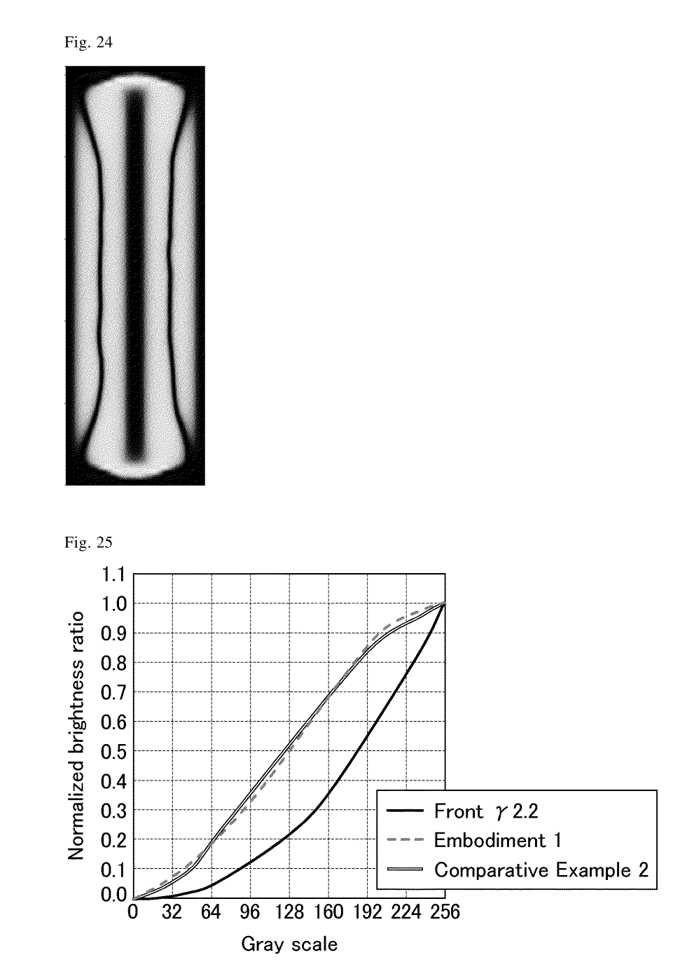

Also in the case of the circularly polarized light system, transmittance and viewing angle in the electrode structure of Embodiment 1 were compared with those in the electrode structure of Comparative Example 2. The transmittance in Embodiment 1 (FIG. 7, transmittance: 26.2%) was almost equal to that in Comparative Example 2 (FIG. 24 described below, transmittance: 26.1%).

The liquid crystal display device including the liquid crystal display panel of Embodiment 1 may appropriately include components (e.g., light source) provided to usual liquid crystal display devices. The same shall apply to the following embodiments.

### Embodiment 2

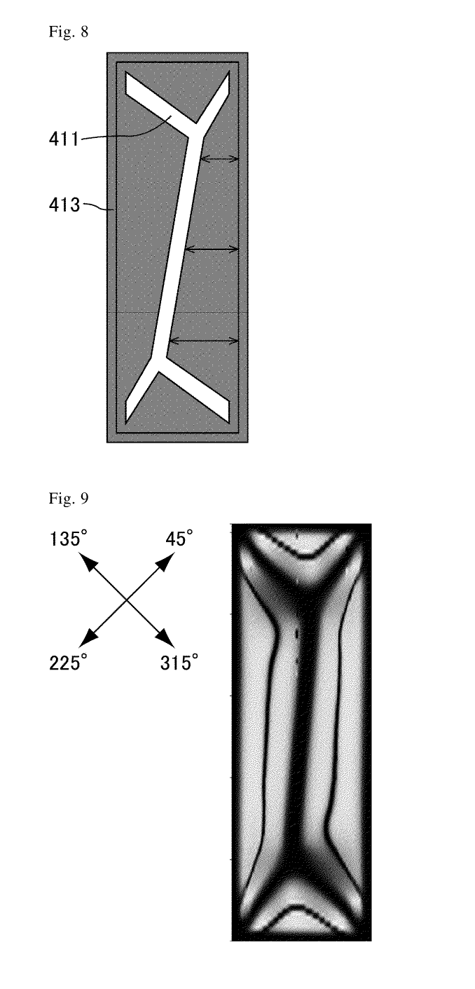

FIG. 8 is a schematic plan view of a pixel electrode structure of a liquid crystal display panel according to Embodiment 2.

In Embodiment 1, the linear portion of the pixel electrode in the center of the pixel is disposed parallel to the left and right linear portions (vertical direction in the schematic plan view) of the common electrode. In Embodiment 2, the linear portion of the pixel electrode is arranged diagonally to the linear portions of the common electrode, so that the width of the space between the pixel electrode 411 and the first common electrode 413 is inclined. Since different space widths provide different electric fields even under the same applied voltage, this structure provides a multi V-T structure and thereby further improves viewing angle characteristics. The other configurations of Embodiment 2 are the same as those of Embodiment 1.

FIG. 9 is a schematic view showing a transmitted light distribution under application of a voltage of 6 V in an electrode structure of Embodiment 2; and polarization axes of a linearly polarizing plate. The transmittance was 22.6%.

### Embodiment 3

FIG. 10 is a schematic plan view of a pixel electrode structure of a liquid crystal display panel according to Embodiment 3.

A pixel electrode 511 in the center of the pixel has two bend points to allow the space between the pixel electrode 511 and a first common electrode 513 to be inclined. Thereby, a multi V-T structure can be achieved, further improving viewing angle characteristics. The other configurations are the same as those of Embodiment 1.

FIG. 11 is a schematic view showing a transmitted light distribution under application of a voltage of 6 V in an electrode structure of Embodiment 3; and polarization axes of a linearly polarizing plate. The transmittance was 22.8%.

### Embodiment 4

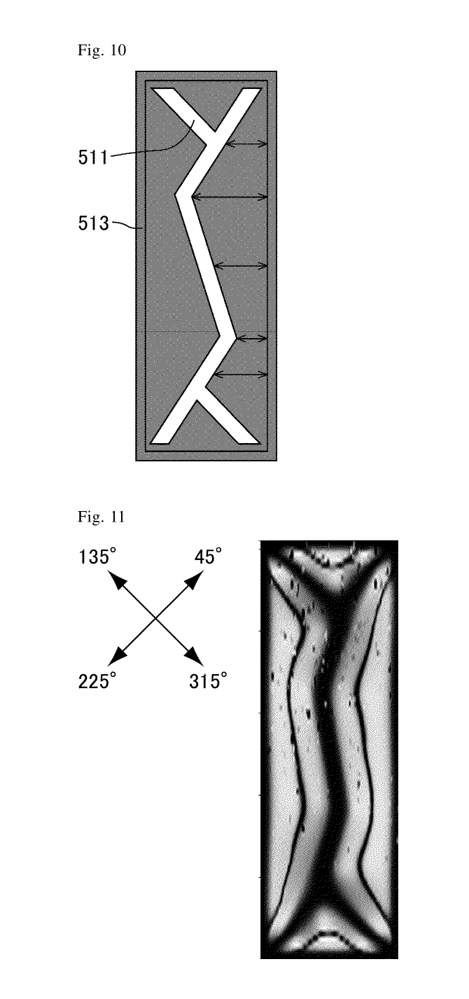

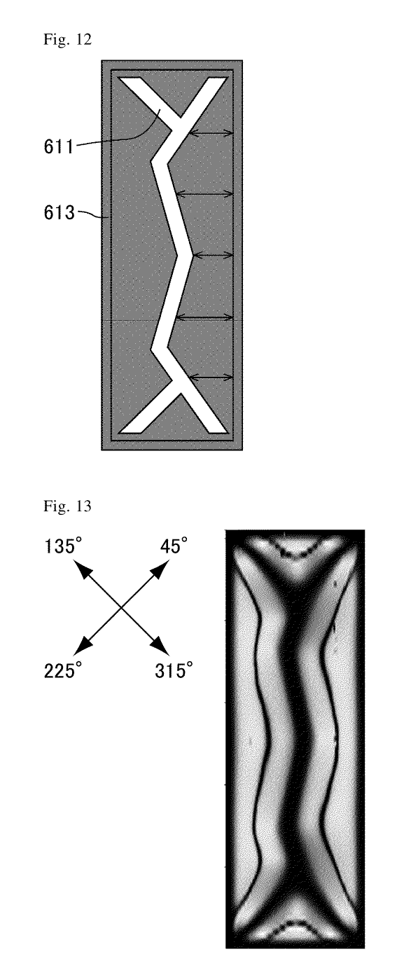

FIG. 12 is a schematic plan view of a pixel electrode structure of a liquid crystal display panel according to Embodiment 4.

A pixel electrode 611 in the center of the pixel has three bend points to allow the space between the pixel electrode 611 and a first common electrode 613 to be inclined. Thereby, a multi V-T structure can be achieved, further improving viewing angle characteristics. The other configurations are the same as those of Embodiment 1.

FIG. 13 is a schematic view showing a transmitted light distribution under application of a voltage of 6 V in an electrode structure of Embodiment 4; and polarization axes of a linearly polarizing plate. The transmittance was 22.4%.

Thus, the transmitted light distributions in the electrode structures of Embodiments 2 to 4 under application of a voltage of 6 V in the linearly polarized light system were described above. All the pixels are 17 μm×51 μm in size. Table 1 below shows the transmittances under application of a voltage of 6 V in Embodiments 1 to 4 and Comparative Examples 1 and 2 with a linearly polarizing plate. The transmittances of Embodiment 2, Embodiment 3, and Embodiment 4 were 22.6%, 22.8%, and 22.4%, respectively, and all of them were equal to or greater than the transmittance (22.4%) of Comparative Example 2. It is one feature of Embodiments 2 to 4 that the multi V-T structure can be achieved as a result of the multi-space structure and thereby viewing angle characteristics are more improved than those in Embodiment 1 while transmittance is maintained.

### Comparative Example 1

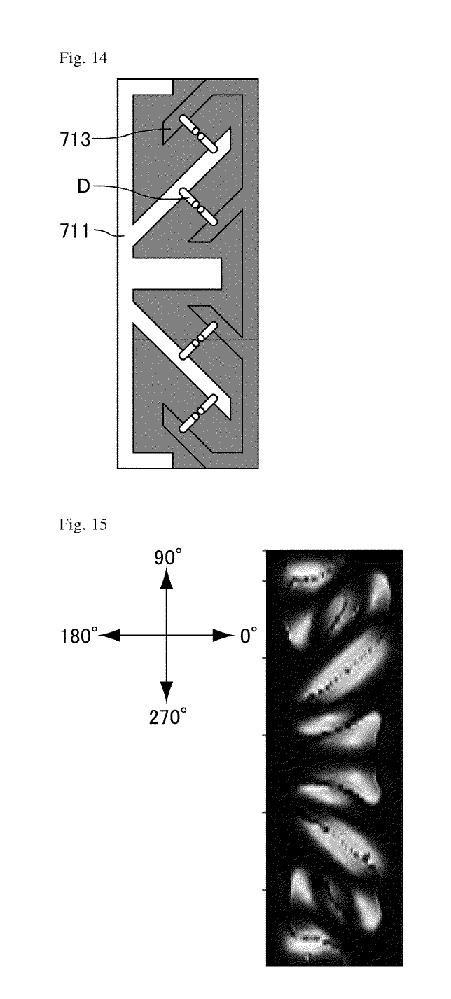

FIG. 14 is a schematic plan view showing a pixel electrode structure of a liquid crystal display panel according to Comparative Example 1.

FIG. 15 is a schematic view showing a transmitted light distribution under application of a voltage of 6 V in an electrode structure of Comparative Example 1; and polarization axes of a linearly polarizing plate. The transmittance was 10%.

### Comparative Example 2

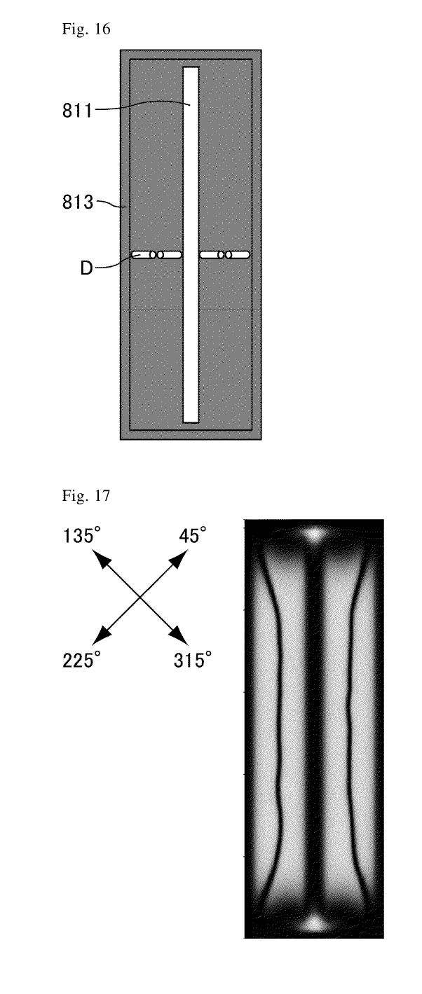

FIG. 16 is a schematic plan view showing a pixel electrode structure of a liquid crystal display panel according to Comparative Example 2.

FIG. 17 is a schematic view showing a transmitted light distribution under application of a voltage of 6 V in an electrode structure of Comparative Example 2; and polarization axes of a linearly polarizing plate. The transmittance was 22.4%.

TABLE 1

| | Transmittance (%) of |
|---|---|
| | pixel (17 × 51 μm) |
| | at 6 V |
| Embodiment 1 | 23 |
| Embodiment 2 | 22.6 |
| Embodiment 3 | 22.8 |
| Embodiment 4 | 22.4 |
| Comparative Example 1 | 10 |
| Comparative Example 2 | 22.4 |

FIGS. 18 to 20 are graphs showing γ characteristics in Embodiment 1 and Comparative Example 2 with linearly polarized light.

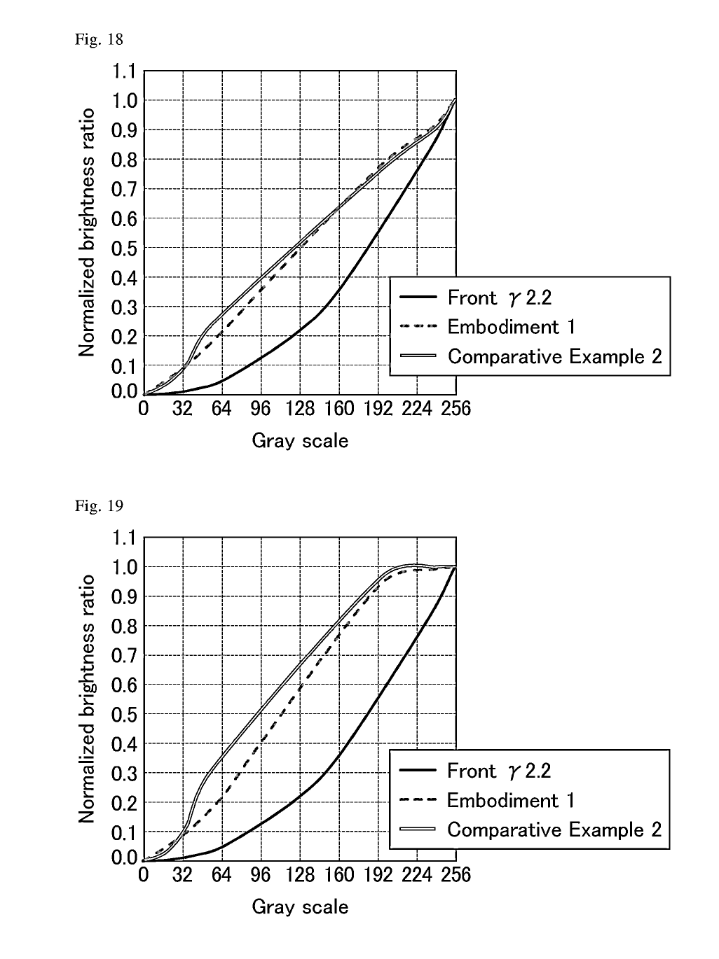

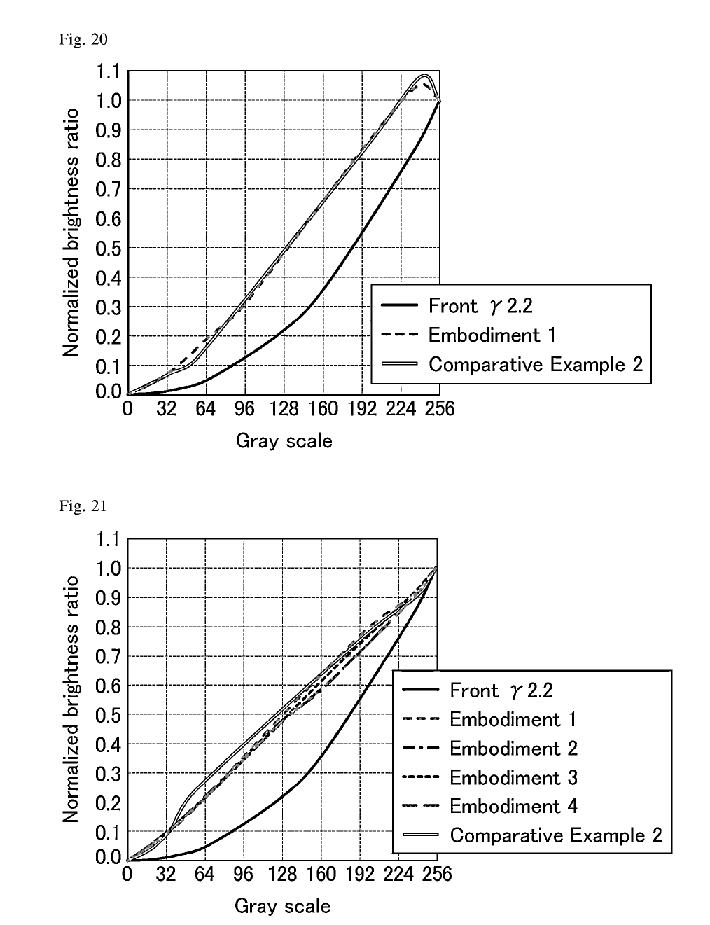

The γ characteristics in Embodiment 1 and Comparative Example 2, which have the similar transmittance, at a polar angle of 60° and an azimuth of 45° to 225°, at a polar angle of 60° and an azimuth of 0° to 180°, and at a polar angle of 60° and an azimuth of 90° to 270° are shown in FIG. 18, FIG. 19, and FIG. 20, respectively. As the curve is closer to the curve of γ=2.2, floating white can be further decreased when viewed from oblique directions. These figures indicate that in Embodiment 1, which forms four domains, viewing angle characteristics at an azimuth of 0° to 180° are especially improved as compared with those in Comparative Example 2, which forms only two domains. The viewing angle characteristics in Embodiment 1, Comparative Example 1, and Comparative Example 2 are evaluated as good, good, and poor, respectively.

FIGS. 21 to 23 are graphs showing γ characteristics in Embodiments 1 to 4 and Comparative Example 2 with linearly polarized light.

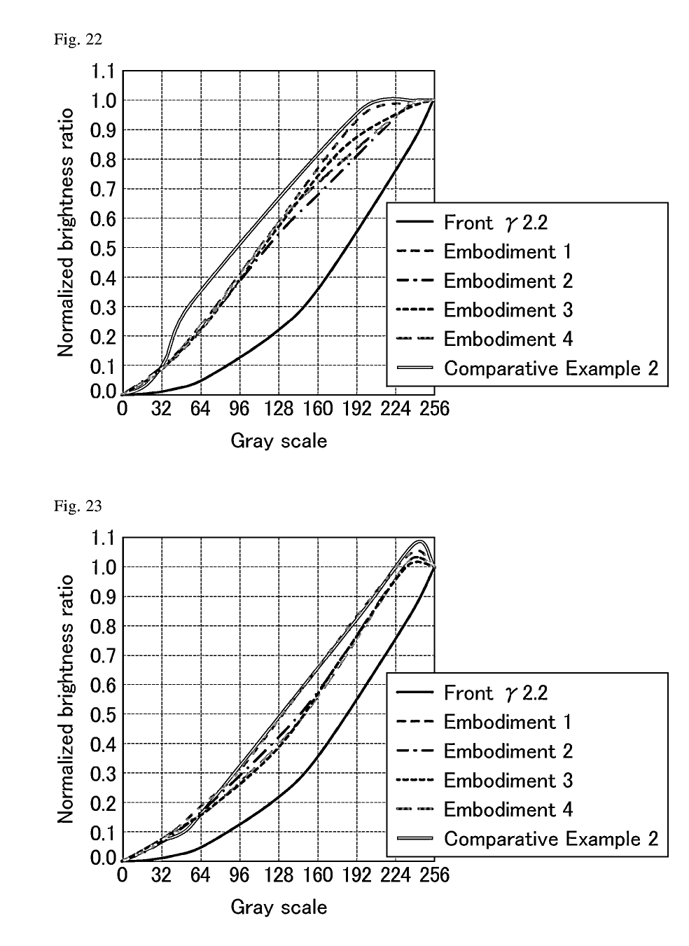

The γ characteristics in Embodiments 2 to 4 at a polar angle of 60° and an azimuth of 45° to 225°, at a polar angle of 60° and an azimuth of 0° to 180°, and at a polar angle of 60° and an azimuth of 90° to 270° are shown in FIG. 21, FIG. 22, and FIG. 23, respectively. For comparison, γ characteristics in Embodiment 1 and Comparative Example 2 shown in FIGS. 18 to 20 are also shown in FIGS. 21 to 23. Viewing angle characteristics in Embodiments 2 to 4 are found to be improved at all of the three azimuths as compared with those in Comparative Example 2. Moreover, viewing angle characteristics in Embodiments 2 to 4 are improved as compared with those in Embodiment 1. This indicates that diagonally arranging the pixel electrode in the center portion and/or providing the pixel electrode with one or more bend points to incline the space are suitable and achieve the multi V-T structure, thereby further improving viewing angle characteristics. This improving effect can be obtained if the common electrode, rather than the pixel electrode, is inclined and/or provided with a bend point.

FIG. 24 is a schematic view showing a transmitted light distribution under application of a voltage of 6 V in an electrode structure of Comparative Example 2 with a circularly polarizing plate.

FIGS. 25 to 27 are graphs showing γ characteristics in Embodiment 1 and Comparative Example 2 with circularly polarized light.

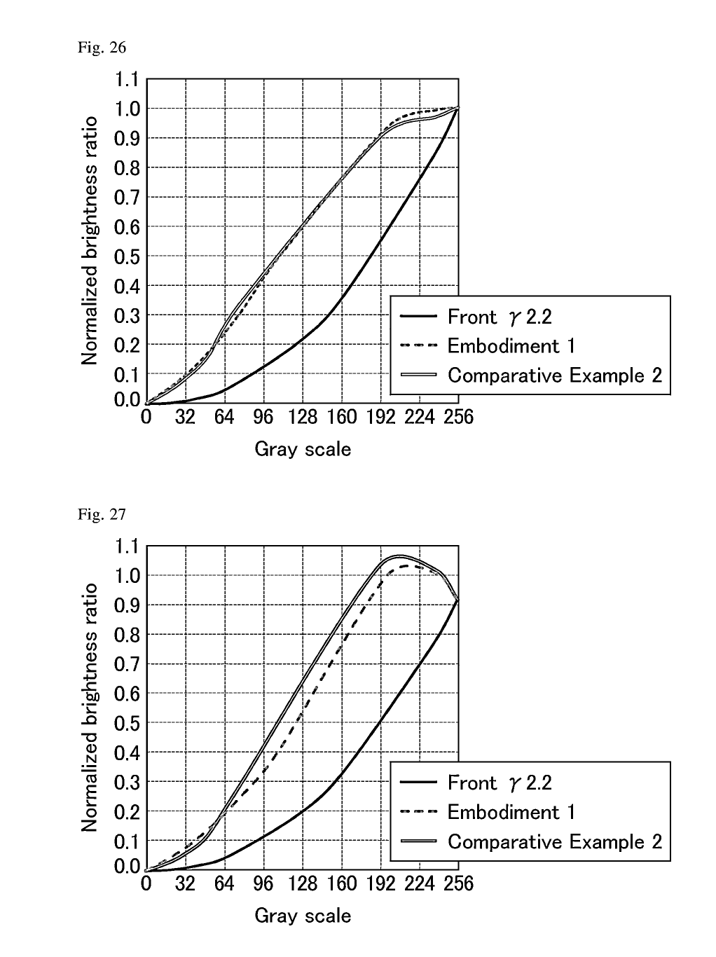

The γ characteristics at an azimuth of 45° to 225° and a polar angle of 60°, at an azimuth of 0° to 180° and a polar angle of 60°, and at an azimuth of 90° to 270° and a polar angle of 60° in Embodiment 1 were compared with those in Comparative Example 2 (shown in FIG. 25, FIG. 26, and FIG. 27, respectively). Embodiment 1 exhibited improved characteristics at an azimuth of 90° to 270° and a polar angle of 60° as compared with Comparative Examples 2. This indicates that the electrode structure of the present invention achieves a multi-domain structure and a multi V-T structure and thereby improves viewing angle characteristics even in the circularly polarized light system.

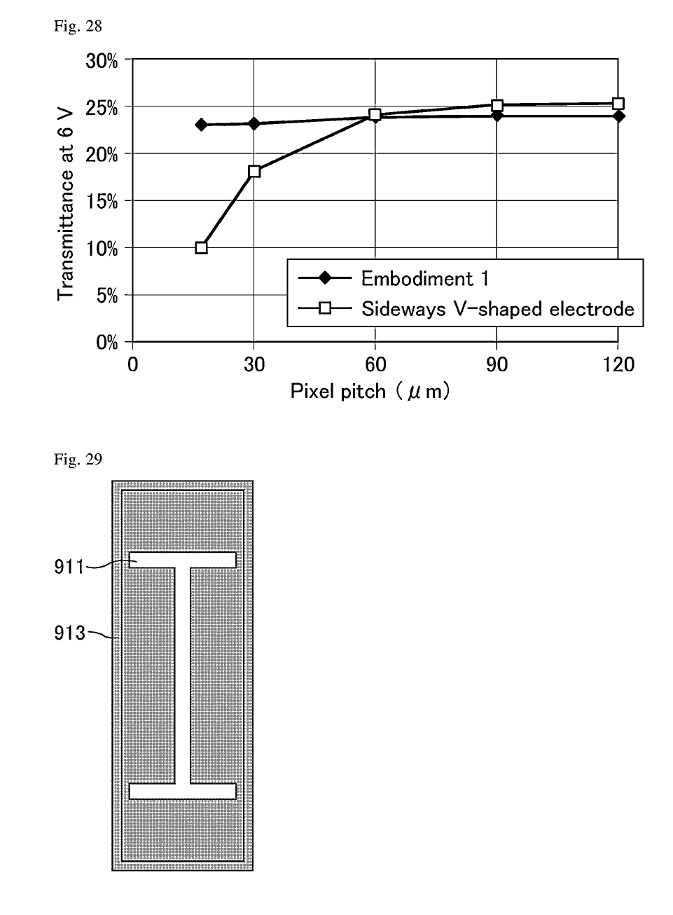

FIG. 28 is a graph showing relation between pixel pitch and transmittance in the electrode structure of Embodiment 1 and the electrode structure of Comparative Example 1. It is found from FIG. 28 that if the pixel pitch (a pixel pitch along the short side of the pixel) is 60 μm or smaller, the electrode structure of Embodiment 1 provides excellent transmittance. The pixel pitch is more preferably 50 μm or smaller, and even more preferably 30 μm or smaller. The liquid crystal display panel of this embodiment is easily manufactured and achieves high transmittance and wide viewing angles.

In the following, electrode structures which allow a four-direction multi-domain structure are described as Embodiments 5 to 7.

### Embodiment 5

FIG. 29 is a schematic plan view showing a pixel electrode structure of a liquid crystal display panel according to Embodiment 5. The structure of Embodiment 5 is obtained by forming a pixel electrode 911 having T-shaped portions instead of the pixel electrode 11 with Y-shaped bifurcated portions of Embodiment 1. The other configurations are the same as those of Embodiment 1.

### Embodiment 6

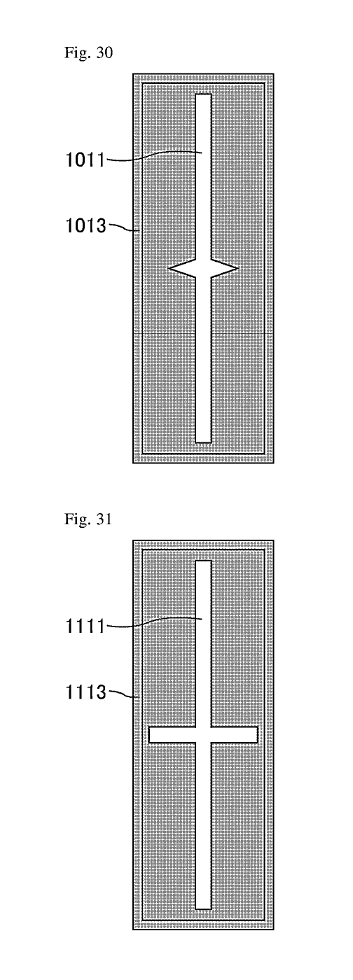

FIG. 30 is a schematic plan view showing a pixel electrode structure of a liquid crystal display panel according to Embodiment 6. The structure of Embodiment 6 is obtained by arranging the Y-shaped bifurcated portions of the pixel electrode 11 of Embodiment 1 in the center of the pixel to provide a pixel electrode 1011. The other configurations are the same as those of Embodiment 1.

### Embodiment 7

FIG. 31 is a schematic plan view showing a pixel electrode structure of a liquid crystal display panel according to Embodiment 7. Embodiment 7 is obtained by arranging the T-shaped bifurcated portions of the pixel electrode 911 of Embodiment 5 in the center of the pixel to provide a pixel electrode 1111. The other configurations are the same as those of Embodiment 5. Also with these electrode shapes according to Embodiments 5 to 7, viewing angle characteristics are improved due to the multi-domain structure while transmittance can be sufficiently improved, achieving the same effects as Embodiment 1.

The electrode structures and the like of the liquid crystal display panel and the liquid crystal display device according to the present invention can be confirmed by observing the TFT substrate and the counter substrate with a microscope such as a scanning electron microscope (SEM).

The each form in the above embodiments may be appropriately combined as long as the combination is not beyond the spirit of the present invention.

The present application claims priority to Patent Application No. 2011-283983 filed in Japan on Dec. 26, 2011 under the Paris Convention and provisions of national law in a designated State, the entire contents of which are hereby incorporated by reference.

### REFERENCE SIGNS LIST

10, 110, 210, 310: array substrate
11, 111, 211, 311, 411, 511, 611, 711, 811, 911, 1011, 1111: pixel electrode
13, 113, 213, 223, 313, 413, 513, 613, 713, 813, 913, 1013, 1113: first common electrode
15, 17, 115, 117, 125, 215, 217, 315, 317: insulating layer
19, 21, 119, 121, 219, 221, 319, 321: substrate
20, 120, 220, 320: counter substrate
30, 130, 230, 330: liquid crystal layer
31: liquid crystal (liquid crystal molecule)
123, 323: second common electrode
E_{W}: transverse electric field
E_{L}: vertical electric field
E_{W+L}: transverse electric field and vertical electric field
D: liquid crystal molecule (director)
Data: data bus line
Domain: domain

1. A liquid crystal display panel comprising:
a first substrate and a second substrate facing each other; and
a liquid crystal layer interposed between the substrates,
the first substrate and/or the second substrate including a vertical alignment film on the liquid crystal layer side to align liquid crystal molecules, at a voltage lower than a threshold voltage, in the vertical direction to main surfaces of the substrates,
the first substrate and/or the second substrate including a common electrode,
the common electrode including a grid-shaped first common electrode,
the first substrate including a pixel electrode, and
the pixel electrode being branched.

2. The liquid crystal display panel according to claim 1,
wherein the pixel electrode is disposed in a grid surrounded by the first common electrode in a plan view of main surfaces of the substrates.

3. The liquid crystal display panel according to claim 1,
wherein the pixel electrode includes a linear portion, and
both ends of the linear portion are bifurcated.

4. The liquid crystal display panel according to claim 1,
wherein the pixel electrode includes a plurality of linear portions, and
the plurality of linear portions intersect each other.

5. The liquid crystal display panel according to claim 1,
wherein the common electrode further includes a second common electrode, and
the second common electrode overlaps at least part of the pixel electrode or the first common electrode.

6. The liquid crystal display panel according to claim 1,
wherein the pixel electrode and the first common electrode each include a linear portion, and
the space between the linear portion of the pixel electrode and the linear portion of the first common electrode varies in one pixel.

7. The liquid crystal display panel according to claim 1,
wherein the pixel electrode and/or the first common electrode include/includes a linear portion including one or more bend points.

8. The liquid crystal display panel according to claim 1,
wherein the pixel electrode has a shape which allows liquid crystal molecules to be aligned in at least four directions, at a voltage not lower than a threshold voltage, in a plan view of main surfaces of the substrates.

9. The liquid crystal display panel according to claim 1,
wherein either one of the first substrate and the second substrate includes a grid-shaped common electrode.

10. The liquid crystal display panel according to claim 1,
wherein both of the first substrate and the second substrate include a grid-shaped common electrode.

11. The liquid crystal display panel according to claim 1,
wherein the liquid crystal display panel further includes a polarizing plate, and
the polarizing plate is a linearly polarizing plate.

12. The liquid crystal display panel according to claim 1,
wherein the liquid crystal display panel further includes a polarizing plate, and
the polarizing plate is a circularly polarizing plate.

13. The liquid crystal display panel according to claim 1,
wherein the liquid crystal layer includes liquid crystal molecules having a positive dielectric constant anisotropy.

14. The liquid crystal display panel according to claim 1,
wherein the liquid crystal layer includes liquid crystal molecules having a negative dielectric constant anisotropy.

15. A liquid crystal display device comprising
the liquid crystal display panel according to claim 1.
